(19) United States
(12) Patent Application Publication
(10) Pub. No.: US 2023/0104843 A1
(43) Pub. Date: Apr. 6, 2023

(54) DETECTING STATIONARY NON-PARTICIPANTS OF TRAFFIC

(71) Applicant: Waymo LLC, Mountain View, CA (US)

(72) Inventors: Qichi Yang, Foster City, CA (US); Jingxuan Hou, Mountain View, CA (US); Zijian Guo, Sunnyvale, CA (US)

(21) Appl. No.: 17/951,001

(22) Filed: Sep. 22, 2022

Related U.S. Application Data
(60) Provisional application No. 63/250,003, filed on Sep. 29, 2021.

(51) Int. Cl. G06N 3/04; G08G 1/01

(52) U.S. Cl. CPC G06N 3/0454; G08G 1/0133

(57) ABSTRACT

Methods, systems, and apparatus, including computer programs encoded on computer storage media, for predicting the intent of an agent in an environment. One of the methods includes obtaining context data characterizing an environment, the context data comprising data characterizing a plurality of agents in the environment; and generating, based on processing the context data using a neural network having a plurality of network parameters, a respective predicted stationary state classification over a plurality of categories for each of one or more target agents of the plurality of agents in the environment, the categories including one or more categories that indicate that the target agent is a stationary non-participant of traffic in the environment.

### CROSS-REFERENCE TO RELATED APPLICATIONS

This application claims priority to U.S. Provisional Application No. 63/250,003, filed on Sep. 29, 2021. The disclosure of the prior application is considered part of and is incorporated by reference in the disclosure of this application.

### BACKGROUND

This specification relates to predicting the intent of an agent in an environment.

The environment may be a real-world environment, and the agent may be, e.g., a vehicle in the environment. Predicting the intents of agents is a task required for motion planning, e.g., by an autonomous vehicle.

Autonomous vehicles include self-driving cars, boats, and aircraft. Autonomous vehicles use a variety of on-board sensors and computer systems to detect nearby objects and use such detections to make control and navigation decisions.

Some autonomous vehicles have on-board computer systems that implement neural networks, other types of machine learning models, or both for various prediction tasks, e.g., object classification within images. For example, a neural network can be used to determine that an image captured by an on-board camera is likely to be an image of a nearby car. Neural networks, or for brevity, networks, are machine learning models that employ multiple layers of operations to predict one or more outputs from one or more inputs. Neural networks typically include one or more hidden layers situated between an input layer and an output layer. The output of each layer is used as input to another layer in the network, e.g., the next hidden layer or the output layer.

Each layer of a neural network specifies one or more transformation operations to be performed on input to the layer. Some neural network layers have operations that are referred to as neurons. Each neuron receives one or more inputs and generates an output that is received by another neural network layer. Often, each neuron receives inputs from other neurons, and each neuron provides an output to one or more other neurons.

An architecture of a neural network specifies what layers are included in the network and their properties, as well as how the neurons of each layer of the network are connected. In other words, the architecture specifies which layers provide their output as input to which other layers and how the output is provided.

The transformation operations of each layer are performed by computers having installed software modules that implement the transformation operations. Thus, a layer being described as performing operations means that the computers implementing the transformation operations of the layer perform the operations.

Each layer generates one or more outputs using the current values of a set of parameters for the layer. Training the neural network thus involves continually performing a forward pass on the input, computing gradient values, and updating the current values for the set of parameters for each layer using the computed gradient values, e.g., using gradient descent. Once a neural network is trained, the final set of parameter values can be used to make predictions in a production system.

### SUMMARY

This specification describes a system implemented as computer programs on one or more computers in one or more locations that generates predicted classifications for one or more agents in an environment. The agent may be any type of vehicle including, for example, cars, trucks, motorcycles, busses, recreational vehicles, amusement park vehicles, farm equipment, construction equipment, trams, golf carts, trains, and trolleys.

In particular, the predicted classification generated by the system specifies whether an agent that is currently stationary is an active participant of the traffic in the environment, i.e., specifies whether the agent will likely soon begin moving as part of traffic flow. In some cases, in the case of specifying that the agent is not an active participant of the traffic in the environment, the predicted classification additionally specifies which specific stationary state the agent is in. For example, the predicted classification generated for each of one or more agents in the environment can include scores for each of a set of stationary agent states, i.e., in addition to a score for an active agent state, with each score representing an estimated likelihood that the agent is currently in the state. For example, the set of stationary agent states can include one or more of: parked, double parked, pulled over, or stalled.

As used in this specification, a parked agent refers an agent that is not moving and is not running (i.e., not turned on). For comparison, a stopped agent or a standing agent may be an active participant of the traffic that is not moving but is running (i.e., turned on), and a moving agent may be an active participant that is currently in motion. A double parked agent refers to an agent parked parallel to another agent that is properly parked, e.g., in a stall or on a parking lane of a street. A pulled over agent refers to an agent stopped at least partially off of an active roadway, and usually is running (i.e., turned on). A stalled agent refers to an agent that is incapacitated or otherwise stopped, e.g., in a parking of a street or travel lane of an active runway.

For example, the predicted classifications may be made by an on-board computer system of an autonomous vehicle navigating through the environment and the target agents may be agents that have been detected by the sensors of the autonomous vehicle. The predicted classifications can then be used by a planning system of the on-board system to control the autonomous vehicle, i.e., to plan the future motion of the vehicle based in part on the predicted classifications of other agents in the environment.

As another example, the predicted classifications may be made in a computer simulation of a real-world environment being navigated through by a simulated autonomous vehicle and the target agents. Generating these predictions in simulation may assist in controlling the simulated vehicle, in testing the realism of certain situations encountered in the simulation, and in ensuring that the simulation includes surprising interactions that are likely to be encountered in the real-world. More generally, generating these predictions in simulation can be part of testing the control software of a real-world autonomous vehicle before the software is deployed on-board the autonomous vehicle, of training one or more machine learning models that will later be deployed on-board the autonomous vehicle or both.

When the planning system of the on-board system receives the predicted classification data, the planning system can use the predicted classification data to generate planning decisions that plan a safe and comfortable future trajectory of the autonomous vehicle, i.e., to generate a new planned vehicle trajectory.

In various cases, identifying an agent as non-participant of traffic may indicate that it is likely not going to move soon and therefore the autonomous vehicle would have time to take actions to avoid the agent. Meanwhile, when an agent is not identified as non-participant of the traffic, but instead as an active agent that is likely to move as part of the traffic flow but that is currently stationary, the autonomous vehicle may treat the agent as part of traffic and/or monitor the movements of the agent more closely so as to be able to respond to its movements properly.

For example, the predicted classification data may include a prediction that a particular surrounding agent in front of the autonomous vehicle is likely a parked agent rather than an agent that is going to move in the near future as part of moving traffic. In this example, the planning system can generate a new planned vehicle trajectory that passes or navigates around the parked agent, e.g., by autonomously controlling the steering of the autonomous vehicle. The autonomous vehicle therefore avoids unnecessary braking or waiting too long for a parked vehicle to move.

As another example, if the predicted classification data alternatively includes a prediction that the particular surrounding agent in front of the autonomous vehicle is likely an active agent that is going to move in the near future as part of moving traffic, the planning system can generate a different new planned vehicle trajectory that yields to or waits behind the active agent, so as to avoid cutting in front of the active agent that unexpectedly pulls into the traffic flow.

The subject matter described in this specification can be implemented in particular embodiments so as to realize one or more of the following advantages.

The technology described herein may allow an on-board system of an autonomous (or semi-autonomous) vehicle to make accurate determinations of whether other stationary agents in an environment surrounding the vehicle are active participants of the ongoing traffic and, in the case of a negative determination, to additionally make determinations of which specific stationary states the agents are in. The technology described herein may enable the on-board system to make planning decisions that cause the vehicle to travel along a safe, smooth, and comfortable trajectory. By making planning decisions according to the stationary state classification predictions of other surrounding agents, the autonomous vehicle may be more responsive to its environment and less likely to cause collisions due to sudden movement of another agent that was previously in stationary state. This may also improve passenger experience with the autonomous vehicle, as the passenger may avoid having to wait in vain for another parked agent to yield. The technology described herein may also improve the training of a planning model by providing additional signals that accurately characterize the intent of the other surrounding agents to the planning model which, once trained, can be deployed on the autonomous vehicle to generate higher quality planning outputs that plan a future trajectory for the autonomous vehicle. That is, the technology allows for existing training data (e.g., driving log data) to be utilized in a way that increases its value to allow for the planning model to outperform the state-of-the-art on vehicle trajectory planning tasks.

In addition, because of the unified processing pipeline and the sparse property of vectorized input data, the described system can achieve significant performance improvement compared to conventional systems, e.g., those that generate similar classification predictions by operating on engineered features or top down rasterized representations, while saving a significant amount of the computation resources (e.g., memory, computing power, or both). For example, by making use of vectorized representations of the scenes in the environment, the described system avoids the lossy rendering steps that are required by existing systems that represent the scene in the environment as a rasterized image, the resolution of which is oftentimes limited. The described system can thus preserve sensitive features such as distance features (e.g., passing gap or distance to the curb) which are imperative to making stationary state classification predictions. As another example, the unified processing pipeline including global feature encoding allows for the system to avoid the limitations on reception field and context agent processing capability as experienced by some conventional systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example on-board system.

FIG. 2 is a flow diagram of an example process for determining a classification for each of one or more target agents in an environment.

FIG. 3 is an illustration of an example environment from a birds-eye view.

FIG. 4 is an illustration of operations performed by an example classification neural network.

Like reference numbers and designations in the various drawings indicate like elements.

### DETAILED DESCRIPTION

This specification describes a system implemented as computer programs on one or more computers in one or more locations that generates predicted classifications for one or more agents in an environment. For example, the environment can be an environment in the vicinity of a vehicle as it drives along a roadway. The term “vicinity,” as used in this specification, refers to the area of the environment that is within the sensing range of one or more sensors of the vehicle.

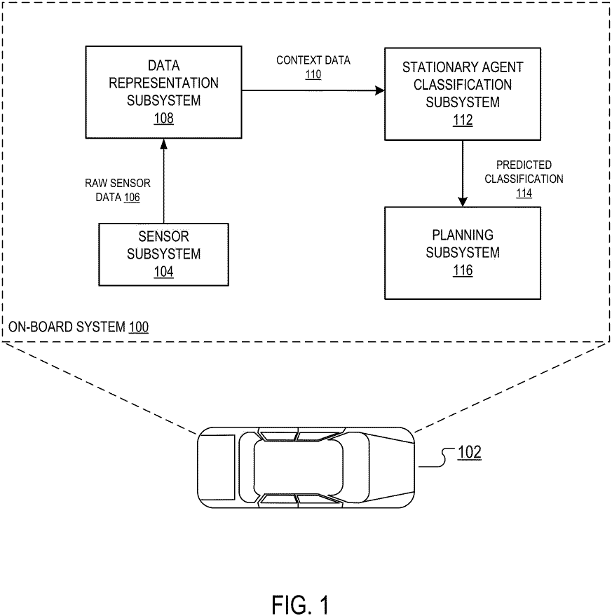

FIG. 1 is a diagram of an example on-board system 100. The on-board system 100 is physically located on-board a vehicle 102. Being on-board the vehicle 102 means that the on-board system 100 includes components that travel along with the vehicle 202, e.g., power supplies, computing hardware, and sensors. In some cases, the vehicle 102 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 102 can autonomously apply the brakes if a prediction indicates that a human driver is about to collide with another vehicle. As another example, the vehicle 102 can have an advanced driver assistance system (ADAS) that assists a human driver of the vehicle 102 in driving the vehicle 102 by detecting potentially unsafe situations and alerting the human driver or otherwise responding to the unsafe situation. As a particular example, the vehicle 102 can alert the driver of the vehicle 102 or take an autonomous driving action when an obstacle is detected, when the vehicle departs from a driving lane, or when an object is detected in a blind spot of the human driver. In another example, in response to determining that another agent might interact with the vehicle 102, the vehicle 102 can alert the driver or autonomously apply the brakes of the vehicle 102 or otherwise autonomously change the trajectory of the vehicle 102 to prevent an unwanted interaction between the vehicle 102 and the agent. The components of the on-board system 100 are described in more detail below.

Although the vehicle 102 in FIG. 1 is depicted as an automobile, and the examples in this document are described with reference to automobiles, in general the vehicle 102 can be any kind of vehicle. For example, besides an automobile, the vehicle 102 can be another kind of autonomous vehicle that travels along a roadway, e.g., a truck or a motorcycle. Moreover, the on-board system 100 can include components additional to those depicted in FIG. 1 (e.g., a collision detection system or a navigation system).

To enable the safe control of the autonomous vehicle 102, the on-board system 100 includes a sensor subsystem 104 which enables the on-board system 100 to “see” the environment in the vicinity of the vehicle 102. More specifically, the sensor subsystem 104 includes one or more sensors, some of which are configured to receive reflections of electromagnetic radiation from the environment in the vicinity of the vehicle 102. For example, the sensor subsystem 104 can include one or more laser sensors (e.g., LIDAR laser sensors) that are configured to detect reflections of laser light. As another example, the sensor subsystem 104 can include one or more radar sensors that are configured to detect reflections of radio waves. As another example, the sensor subsystem 104 can include one or more camera sensors that are configured to detect reflections of visible light.

The sensor subsystem 104 continually (i.e., at each of multiple time points) captures raw sensor data 106 which can indicate the directions, intensities, and distances travelled by reflected radiation. For example, a sensor in the sensor subsystem 104 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight. The sensor subsystems 104 can also include a combination of components that receive reflections of electromagnetic radiation, e.g., LIDAR systems that detect reflections of laser light, radar systems that detect reflections of radio waves, and camera systems that detect reflections of visible light.

The data representation subsystem 108, also on-board the vehicle 102, receives the raw sensor data 106 from the sensor subsystem 104 and uses the received raw sensor data 106 (and, optionally, additional data available in data repositories stored within the autonomous vehicle 102, or data repositories outside of, but coupled to, the autonomous vehicle, such as in a data center with the data available made to the autonomous vehicle over a cellular or other wireless network) to generate context data 110 that that characterize the agents and environment in the vicinity of the vehicle 102.

The context data 110 can include data characterizing a plurality of agents in the environment, either as of a current time point, or as of one or more previous (or future) time points that precede (or succeed) the current time point. For example, the context data 110 can include data specifying the type of agent (motor vehicle, pedestrian, cyclist, etc.), the agent’s location, heading, speed, trajectory, and so on. As another example, for vehicle agents, the context data 110 can additionally include agent attribute information that includes the state of headlights/taillights of vehicle, door opening status of the vehicle, agent interaction with humans such as passengers, and so on.

The context data 110 can also include data characterizing a plurality of road features in the environment. For example, the road feature data may include static features of the environment, e.g., road graph data characterizing one or more of lane connectivity, lane type, stop lines, speed limits, marked crossing zones, and so on.

The context data 110 can further include data characterizing a plurality of traffic light signals in the environment, e.g., data identifying each traffic light signal, the current state of the signal, and optionally, one or more recent states of the signal. For example, the traffic light data can include data specifying a currently detected signal of the traffic light. As another example, the traffic light data can include data specifying a remaining time until the current signal is changed to another signal.

The context data 110 can be generated in any of a variety of ways. In some implementations, the data representation subsystem 108 can classify groups of raw sensor data 106 from one or more sensors, e.g., a camera sensor, a LIDAR sensor, or both, as being measures of another agent in the environment. A group of sensor data can be represented in any of a variety of ways, depending on the kinds of sensor data that are being captured. For example, each group of raw laser sensor data can be represented as a three-dimensional point cloud, with each point having an intensity and a position, where the position is represented as a range and elevation pair. As another example, each group of camera sensor data can be represented as an image patch, e.g., an RGB image patch. Once the one or more groups of raw sensor data 106 are classified as being measures of respective other agents, the data representation subsystem 108 can compile the raw sensor data 106 into a set of context data 110.

In some implementations, the data representation subsystem 108 can process the raw sensor data 106 using one or more machine learning models, and include the outputs of these models as part of the context data 110. For example, the machine learning models can include one or more object detector or classifier models that are configured to process the raw sensor data 106 to generate detection or classification outputs with respect to the objects depicted in the raw sensor data 106, one or more trajectory prediction models that are configured to process the raw sensor data 106 to generate a respective predicted trajectory for an agent depicted in the raw sensor data 106, one or more agent behavior prediction models that are configured to process the raw sensor data 106 to generate intent predictions for an agent depicted in the raw sensor data 106, and so on.

In particular, in some implementations, the context data 110 which characterize the agents and environment in the vicinity of the vehicle 102, includes respective vectorized representations of the agents, road features, and traffic light signals. The vectorized representation approximates agent trajectories and attributes, geographic entities, and traffic light signals using polylines and attributes of the polylines. Thus, in the vectorized representation, agent features, road features, traffic light signals, and optionally, other context or scene information are each represented as polylines (or polygons), i.e., as a sequence of one or more vectors. Each vector has multiple dimensions, with each dimension—i.e., each element of the vector-representing a different aspect of feature.

As an example for illustration, a road feature vector can be a 10-dimension vector of [start_point_x, start_point_y, start_point_z, end_point x, end_point_y, end_point_z, road_line_type, speed_limit, number_vectors, polyline_index]. An agent feature vector can be a 23-dimension vector of [start_point_x, start_point_y, start_point_z, end_point x, end_point_y, end_point_z, w, h, 1, bounding_box_yaw, motion_state, moving_confidence, speed, velocity_x, velocity_y, vel_yaw, left_turn_signal, right_turn_signal, hazard_light_signal, tail_light_signal, object_type, number_vectors, polyline_index]. A traffic light vector can be a 6-dimension vector of [x, y, z, state, valid, confidence]. It will be appreciated that, in other examples, each vector may include more or less dimensions that represent the same or different aspects of the feature.

The data representation subsystem 108 can provide the context data 110 to a stationary agent classification subsystem 112 of the on-board system 100. The stationary agent classification subsystem 112 uses the context data 110 to generate a predicted classification 114 for each of one or more target agents of the plurality of agents in the environment, i.e., to classify each of the one or more target agents in the environment into a category that indicates that the target agent is a stationary non-participant of traffic in the environment. For example, the stationary agent classification subsystem 112 can generate a predicted classification 114 for each of one or more agents in the vicinity of the vehicle 102 that are stationary, i.e., not moving, at the current time point. As will be described further below, to generate the predicted classification for a given target agent, the stationary agent classification subsystem 112 processes the context data 110 using a classification neural network in accordance with parameters of the classification neural network.

In particular, the predicted classification generated by the stationary agent classification subsystem 112 specifies whether an agent that is current stationary is an active participant of the traffic in the environment, i.e., specifies whether the agent will likely soon begin moving as part of traffic flow. In some cases, in the case of specifying that the agent is not an active participant of the traffic in the environment, the predicted classification additionally specifies which specific stationary state the agent is in. For example, the predicted classification generated for each of one or more agents in the environment can include scores for each of a set of stationary agent states, i.e., in addition to a score for an active agent state, with each score representing an estimated likelihood that the agent is currently in the state. For example, the set of stationary agent states can include one or more of: parked, double parked, pulled over, or stalled.

The predicted classifications can be provided to a planning subsystem 116 which generates planning decisions that plan a future trajectory of the vehicle. When a planning subsystem 136 receives the predicted classifications, the planning subsystem 136 can use the one or more predicted classifications 114 to make fully-autonomous or semi-autonomous driving decisions, e.g., to update a planned trajectory for the vehicle 102.

For example, the predicted classification data may include a prediction that a particular surrounding agent in front of the autonomous vehicle is likely a parked agent rather than an agent that is going to move in the near future as part of moving traffic. In this example, the planning subsystem 116 can generate a new planned vehicle trajectory that passes or navigates around the parked agent, e.g., by autonomously controlling the steering of the autonomous vehicle. The autonomous vehicle therefore avoids unnecessary braking or waiting too long for a parked vehicle to move.

As another example, if the predicted classification data alternatively includes a prediction that the particular surrounding agent in front of the autonomous vehicle is likely an active agent that is going to move in the near future as part of moving traffic, the planning subsystem 116 can generate a different new planned vehicle trajectory that yields to or waits behind the active agent, e.g., by applying the brakes of the vehicle 102, so as to avoid cutting in front of the active agent that unexpectedly pulls into the traffic flow.

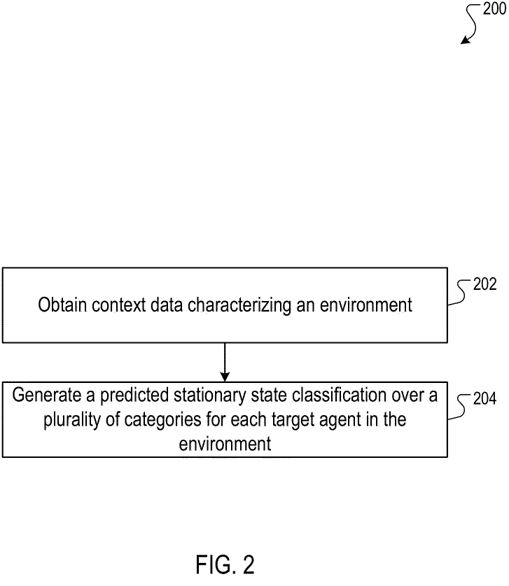

FIG. 2 is a flow diagram of an example process 200 for determining a classification for each of one or more target agents in an environment. For convenience, the process 200 will be described as being performed by a system of one or more computers located in one or more locations. For example, the on-board system 100 of FIG. 1, appropriately programmed in accordance with this specification, can perform the process 200.

The system obtains context data characterizing an environment (step 202). For example, the environment can be a real-world environment in the vicinity of a vehicle that has a plurality of agents, including one or more target agents that are current stationary, i.e., not moving, and the context data is generated from data captured by one or more sensors of the vehicle. As another example, the environment can be a computer simulation of the real-world environment in the vicinity of a simulated vehicle that has a plurality of simulated agents, and the context data includes data that simulates data that would be captured by one or more sensors of the vehicle in the real-world environment.

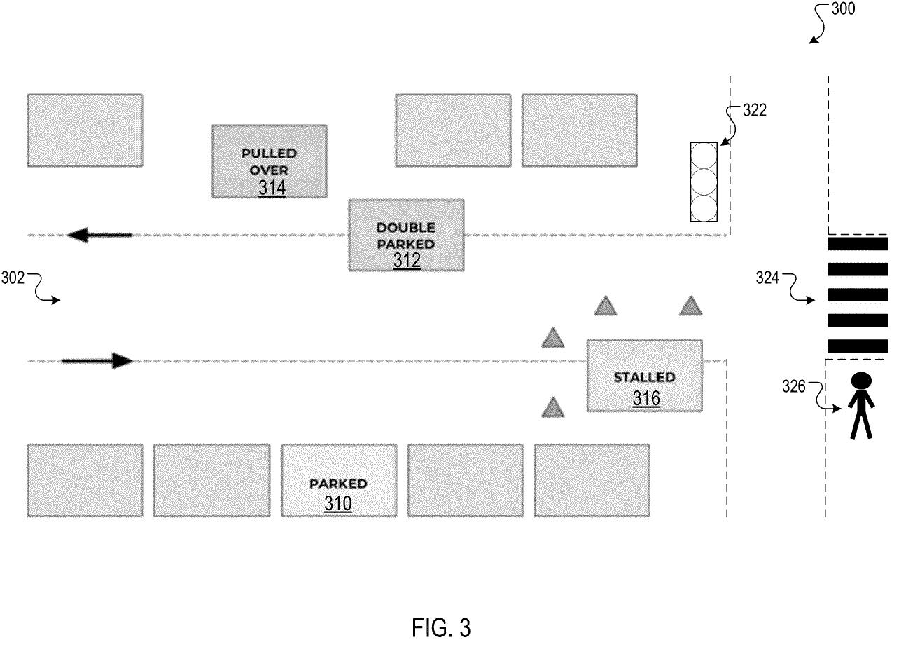

FIG. 3 is an illustration of an example environment 300 from a birds-eye view. The environment 300 has a roadway 302 along which a vehicle, e.g., the vehicle 102 of FIG. 1, may be driven. An agent 310 is parked alongside one side of the roadway 302. In front of the agent 310 on this side of the roadway 302 is a stalled agent 316 which, as illustrated, is surrounded by traffic cones, although this may not always be the case. On the other side of the roadway 302 are a double parked agent 312 that is partially blocking the roadway 302, and a pulled over agent 314. The environment includes an intersection where the roadway 302 cross another roadway. The intersection includes a traffic light 322 and a cross walk 324. A pedestrian 326 is crossing the roadway 326 in cross walk 324.

The context data can include one or more of: (i) agent feature data that characterizes the plurality of agents in the environment, (ii) road feature data that characterizes the plurality of road features in the environment, or (iii) traffic light feature data that characterizes the plurality of traffic light signals in the environment.

In the example of FIG. 3, the agent feature data can include, for each agent in the environment 300, e.g., agent 310, 312, 314, or 316, the type of agent (motor vehicle, pedestrian, cyclist, etc.), the agent’s location, heading, speed, trajectory, and so on. For each vehicle agent, the context data can additionally include agent attribute information that includes the state of headlights/taillights of vehicle, door opening status of the vehicle, agent interaction with humans such as passengers, and so on. The road feature data can include data that identifies lanes and marked crossing zones, e.g., cross walk 223, within roadways, e.g., roadway 302, in the environment 300. The traffic light feature data can include a current signal of the traffic light, e.g., a green signal of traffic light 322, at an intersection a remaining time until the current signal is changed to another signal, and so on.

In some implementations, the context data can include respective vectorized representations of the plurality of agents, road features, and traffic light signals. The vectorized representations can include: (i) one or more agent vectors characterizing the plurality of agents in the environment, (ii) one or more road feature vectors characterizing the plurality of road features in the environment, or (iii) one or more traffic light vectors characterizing the plurality of traffic light signals in the environment, with each vector having multiple dimensions, with each dimension—i.e., each element of the vector—representing a different aspect of the feature.

The system processes the context data using a classification neural network to generate a respective predicted stationary state classification over a plurality of categories for each of one or more target agents of the plurality of agents in the environment (step 204). The system can generate a predicted stationary state classification only for each of one or more target agents that have been indicated as stationary, e.g., according to the agent feature data in the obtained context data or another data source. The categories can generally include one or more categories that indicate that the target agent is a stationary non-participant of traffic in the environment, in addition to a category that indicates that the target agent is an active participant of traffic in the environment.

In some implementations, the one or more categories include: a first category that indicates that the target agent is a double parked vehicle in the environment; a second category that indicates that the target agent is a parked vehicle in the environment; a third category that indicates that the target agent is a pulled over vehicle in the environment; a fourth category that indicates that the target agent is a stalled vehicle in the environment; and a fifth category that indicates that the target agent is an active participant of the traffic in the environment.

In some implementations, the classification neural network is multi-class classification model that assigns a score or likelihood to each possible category, namely “double parked vehicle,” “parked vehicle,” “pulled over vehicle,” “stalled vehicle,” or “active participant,” by processing the context data in accordance with the parameters of the classification neural network. Category with the highest score or likelihood among all categories may be selected as a predicted category. For example, with respect to agent 312 depicted in FIG. 3, assigning a higher score to the category of “double parked vehicle” than any other four categories indicates that the agent 312 has been determined to be a stationary non-participant of traffic in the environment, and more particularly a double parked vehicle, by the classification neural network.

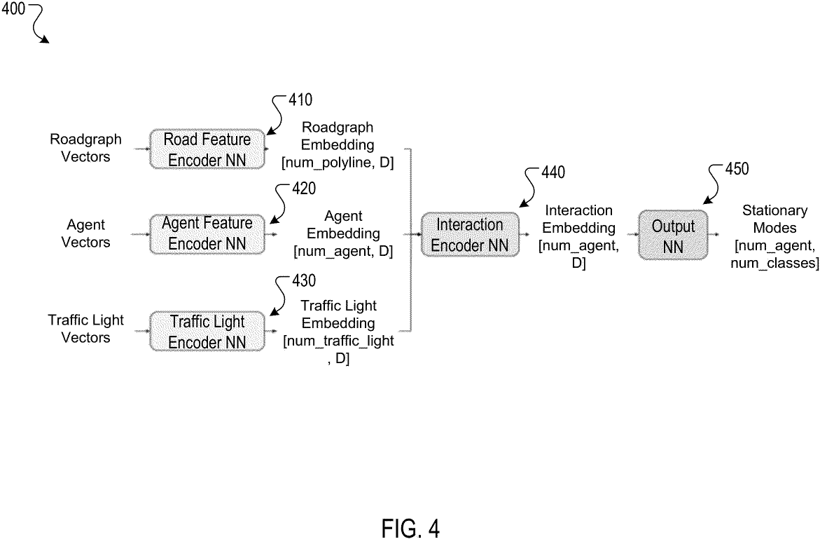

FIG. 4 is an illustration of operations performed by an example classification neural network 400. As illustrated, the classification neural network 400 is a neural network that includes (i) a road feature encoder neural network 410 that generates, from vectorized representation data characterizing a plurality of road features, a respective road feature embedding each of the plurality of the road features; (ii) an agent encoder neural network 420 that generates, from vectorized representation data characterizing a plurality of agents, a respective agent embedding for each of the plurality of agents that characterizes a state of the agent at a current time point; and (iii) a traffic light encoder neural network 430 that generates, from vectorized representation data characterizing a plurality of traffic light signals, a respective traffic light embedding for each of the plurality of traffic light signals that characterizes a state of the traffic light signal at the current time point. An embedding, as used in this specification, is a numeric representation in a latent space that has a fixed dimensionality. That is, the embedding is an ordered collection of numeric or other values that has a fixed number of values.

For a traffic light signal which may be represented by one single vector, the traffic light encoder neural network 430 can generate one vector embedding for the single vector representing the traffic light signal. For a road feature which may be represented by a polyline having more than one vectors, the road feature encoder neural network 410 can instead generate one polyline embedding for the polyline having multiple vectors. For example, the road feature encoder neural network 410 can generate one polyline embedding for each polyline that represents a respective lane connectivity feature, where each polyline may include a sequence of multiple vectors sequentially connected to one another in series.

In the example of FIG. 4, the road feature encoder neural network 410, the agent encoder neural network 420, and the traffic light encoder neural network 430 can each be configured as a respective multi-layer perceptron or a recurrent neural network. A multi-layer perceptron is a neural network that includes one or more fully-connected layers. A recurrent neural network is a neural network that includes one or more recurrent layers, e.g., long short-term memory (LSTM) layers or gated recurrent unit (GRU) layers.

The classification neural network 400 also includes an interaction encoder neural network 440 which generates, for each of the one or more target agents of the plurality of agents in the environment, and from the respective road feature embeddings, the respective agent embeddings, and the respective traffic light embeddings, (i) agent interaction embeddings characterizing the states of other agents in the environment relative to the target agent, and (ii) road feature interaction embeddings characterizing the plurality of road features in the environment relative to the target agent. For example, the interaction encoder neural network 440 can be configured as a convolutional neural network, i.e., a neural network that includes one or more convolutional layers, or as an attention neural network, i.e., a neural network that includes one or more attention layers. As used in this specification an attention layer is a neural network layer that includes an attention mechanism, e.g., a multi-head self-attention mechanism.

Furthermore, the classification neural network 400 includes an output neural network 450, which can be configured as a multilayer perceptron, a recurrent neural network, an attention neural network, or the like, that processes the respective agent interaction embeddings and the respective road feature interaction embeddings to generate as output the predicted classification for each target agent in the vicinity of the vehicle. For example, the final layer of the output neural network 450 can be a softmax output layer that generates as output respective scores or likelihoods over a plurality of categories for each target agent. The category with the highest score or likelihood can then be selected as the predicted classification for each target agent.

The process 200, which generally includes one or more forward inference passes through the classification neural network, can be repeatedly performed, e.g., at each of multiple time points, to generate a predicted stationary state classification for each of one or more target agents in the environment that are stationary, i.e., not moving, at the current time point. The system can also perform the process 200 as the classification neural network is being trained on a set of training data derived from the context data to predict whether a target agent in the vicinity of the vehicle is a stationary non-participant of traffic in the environment and if so, which specific stationary state the target agent is in, i.e., in order to determine trained values for the parameters of the classification neural network.

The system can further perform the process 200 as part of the training of another trainable component of the system, e.g., a planning model that is configured to plan a future trajectory of the vehicle conditioned on the predicted classifications. In particular, the predicted classifications generated by the classification neural network can provide the planning model with additional signals that accurately characterize the intent of the other surrounding agents. Thus, once trained, the planning model can be deployed on the vehicle to generate higher quality planning outputs that plan a future trajectory for the vehicle.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining context data characterizing an environment, the context data comprising data characterizing a plurality of agents in the environment; and
generating, based on processing the context data using a neural network having a plurality of network parameters, a respective predicted stationary state classification over a plurality of categories for each of one or more target agents of the plurality of agents in the environment, the categories including one or more categories that indicate that the target agent is a stationary non-participant of traffic in the environment.

2. The method of claim 1, wherein the plurality of categories comprise two or more of:
a first category that indicates that the target agent is a double parked vehicle in the environment,
a second category that indicates that the target agent is a parked vehicle in the environment,
a third category that indicates that the target agent is a pulled over vehicle in the environment, or
a fourth category that indicates that the target agent is a stalled vehicle in the environment.

3. The method of claim 2, wherein the plurality of categories further comprise a fifth category that indicates that the target agent is an active participant of the traffic in the environment.

4. The method of claim 1, wherein the context data characterizing the environment comprises data characterizing a plurality of road features in the environment and data characterizing one or more traffic light signals in the environment.

5. The method of claim 4, wherein:
the data characterizing each of the plurality of road features comprises one or more road feature vectors characterizing the road feature;
the data characterizing each of the plurality of agents comprises one or more agent vectors characterizing the agent; and
the data characterizing each of the plurality of traffic light signals comprises one or more traffic light vectors characterizing the traffic light signal.

6. The method of claim 5, wherein processing the context data using the neural network having the plurality of network parameters comprises:
generating, from the context data, (i) a respective road feature embedding for each of the plurality of road features, (ii) a respective agent embedding for each of the plurality of agents that characterizes a state of the agent at a current time point, and (iii) a respective traffic light embedding for each of the plurality of traffic light signals that characterizes a state of the traffic light signal at the current time point; and
for each of the one or more target agents of the plurality of agents in the environment:
generating, from the respective road feature embeddings, the respective agent embeddings, and the respective traffic light embeddings, (i) agent interaction embeddings characterizing the states of other agents in the environment relative to the target agent, and (ii) road feature interaction embeddings characterizing the plurality of road features in the environment relative to the target agent.

7. The method of claim 6, wherein generating the respective road feature embedding for each of the plurality of road features comprises generating a respective polyline that represent the road feature.

8. The method of claim 6, wherein generating the respective road feature embedding for each of the plurality of road features comprises generating a respective polyline embedding for the respective polyline that represents the road feature using a road feature encoder neural network.

9. The method of claim 6, wherein generating the respective agent embedding and the respective traffic light embedding comprises:
processing the one or more agent vectors using an agent encoder neural network to generate the respective agent embedding; and
processing the one or more traffic light vectors using a traffic light encoder neural network to generate the respective traffic light embedding.

10. The method of claim 9, wherein the agent encoder neural network and the traffic light encoder neural network are each a respective multi-layer perceptron or a recurrent neural network.

11. The method of claim 6, wherein generating the agent interaction embeddings and the road feature interaction embeddings comprises:
processing the respective road feature embeddings, the respective agent embeddings, and the respective traffic light embeddings using a self-attention neural network to generate the agent interaction embeddings and the road feature interaction embeddings.

12. The method of claim 6, wherein generating the predicted classification for the target agent comprises:
processing the respective agent interaction embeddings and the respective road feature interaction embeddings using an output neural network to generate the predicted classification.

13. The method of claim 1, further comprising providing data specifying the predicted classification for the target agent to a planning system of a vehicle to generate planning decisions that plan a future trajectory of the vehicle.

14. The method of claim 13, wherein:
each of the plurality of agents is an agent in a vicinity of the vehicle in the environment, and
the context data comprises data generated from data captured by one or more sensors of the vehicle.

15. The method of claim 13, wherein:
each of the plurality of agents is a simulated agent in a vicinity of a simulated vehicle in a computer simulation of a real-world environment, and
the context data comprises data generated from data that simulates data that would be captured by one or more sensors of the vehicle in the real-world environment.

16. The method of claim 1, wherein obtaining context data characterizing the environment comprises obtaining data indicating that the one or more target agents are stationary at a current time point, and wherein the generating is performed only for target agents that are indicated as stationary at the current time point.

17. A system comprising one or more computers, and one or more storage devices storing instructions that, when executed by the one or more computers, cause the one or more computers to perform operations comprising:
obtaining context data characterizing an environment, the context data comprising data characterizing a plurality of agents in the environment; and
generating, based on processing the context data using a neural network having a plurality of network parameters, a respective predicted stationary state classification over a plurality of categories for each of one or more target agents of the plurality of agents in the environment, the categories including one or more categories that indicate that the target agent is a stationary non-participant of traffic in the environment.

18. The system of claim 17, wherein the plurality of categories comprise two or more of:
a first category that indicates that the target agent is a double parked vehicle in the environment,
a second category that indicates that the target agent is a parked vehicle in the environment,
a third category that indicates that the target agent is a pulled over vehicle in the environment, or
a fourth category that indicates that the target agent is a stalled vehicle in the environment.

19. The system of claim 17, wherein the plurality of categories further comprise a fifth category that indicates that the target agent is an active participant of the traffic in the environment.

20. One or more non-transitory computer-readable storage media storing instructions that when executed by one or more computers cause the one or more computers to perform operations comprising:
obtaining context data characterizing an environment, the context data comprising data characterizing a plurality of agents in the environment; and
generating, based on processing the context data using a neural network having a plurality of network parameters, a respective predicted stationary state classification over a plurality of categories for each of one or more target agents of the plurality of agents in the environment, the categories including one or more categories that indicate that the target agent is a stationary non-participant of traffic in the environment.
